(19) United States
(12) Patent Application Publication
(10) Pub. No.: US 2026/0267348 A1
(43) Pub. Date: Sep. 10, 2026

(54) Humanoid Robot Interface and Workflow

(71) Applicant: Apptronik Inc., Austin, TX (US)

(72) Inventors: Orion Campbell, Austin, TX (US); Nathan Boyd, Austin, TX (US)

(21) Appl. No.: 19/162,543

(22) PCT Filed: Mar. 11, 2024
(86) PCT No.: PCT/US2024/019402

§ 371 Date: Sep. 5, 2025

Related U.S. Application Data
(60) Provisional application No. 63/489,616, filed on Mar. 10, 2023.

(51) Int. Cl. G05D 1/648; G05D 1/223; G05D 1/224; G05D 1/698; G05D 1/86; G05D 109/12; G05D 111/30

(52) U.S. Cl. CPC G05D 1/648; G05D 1/223; G05D 1/2247; G05D 1/6987; G05D 1/86; G05D 2109/12; G05D 2111/32

(57) ABSTRACT

A humanoid robot system includes at least one humanoid robot; and a control system communicably coupled to the at least one humanoid robot and configured to perform operations. The operations include executing a mission creator to create one or more working tasks for the at least one humanoid robot; and executing a mission assignor to assign one or more working tasks to the at least one humanoid robot.

### TECHNICAL FIELD

The present disclosure describes systems and methods associated with a humanoid robot user interface.

### BACKGROUND

UI (User Interface) platforms for robots are conventionally created for robots such as large industrial welding arms, manipulator “collaborative” arms, or AMRs (Autonomous Mobile Robots). These aforementioned robots do not possess nearly the degrees of freedom and advancement of a mobile robot and as such do not provide a level of control and programming as desired for a mobile robot. Further, conventional robotic UIs are typically not easy to use and the software integration is fragmented, since they were developed for highly technical individuals.

### SUMMARY

In an example implementation, a humanoid robot system includes at least one humanoid robot; and a control system communicably coupled to the at least one humanoid robot and configured to perform operations. The operations include executing a mission creator to create one or more working tasks for the at least one humanoid robot; and executing a mission assignor to assign one or more working tasks to the at least one humanoid robot.

In an aspect combinable with the example implementation, the operations further include executing a diagnostic tool on the at least one humanoid robot.

In another aspect combinable one, some, or all of the previous aspects, the operations further include providing a communication from the at least one humanoid robot to a human operator.

In another aspect combinable one, some, or all of the previous aspects, the at least one humanoid robot includes one or more eyes, a mouth, and a chest display.

In another aspect combinable one, some, or all of the previous aspects, the operation of providing the communication from the at least one humanoid robot to the human operator includes activating one or more of the one or more eyes, the mouth, or the chest display to provide a visual communication.

In another aspect combinable one, some, or all of the previous aspects, the communication includes at least one of a boot-up sequence; a boot up greeting; a processing and confirmation communication; a working communication; a greeting during a working task communication; a maintenance mode communication; an error communication; or a charging communication.

In another aspect combinable one, some, or all of the previous aspects, the visual communication includes a light communication with one or more LEDs.

In another aspect combinable one, some, or all of the previous aspects, the control system includes a hand held controller.

In another aspect combinable one, some, or all of the previous aspects, the controller is in wireless communication with the at least one humanoid robot.

In another aspect combinable one, some, or all of the previous aspects, the operations further include controlling the at least one humanoid robot to perform a movement of the at least one humanoid robot with the hand held controller.

In another aspect combinable one, some, or all of the previous aspects, the movement includes at least one of: walking, squatting, rotating an upper body assembly of the at least one humanoid robot, rotating the at least one humanoid robot, picking up an object, or bending over.

In another aspect combinable one, some, or all of the previous aspects, the operations further include presenting an image on the hand-held controller taken by the at least one humanoid robot.

In another aspect combinable one, some, or all of the previous aspects, the operations further include presenting an identification of the at least one humanoid robot among a team of humanoid robots on the hand-held controller.

In another aspect combinable one, some, or all of the previous aspects, the at least one humanoid robot includes a plurality of humanoid robots.

In another aspect combinable one, some, or all of the previous aspects, the plurality of humanoid robots are divided into at least two teams of humanoid robots.

In another aspect combinable one, some, or all of the previous aspects, the operation of executing the mission creator to create one or more working tasks for the at least one humanoid robot includes executing the mission creator to create a mission for at least one team of humanoid robots.

In another aspect combinable with one, some, or all of the previous aspects, the mission includes a plurality of tasks.

In another aspect combinable one, some, or all of the previous aspects, the operation of executing the mission assignor to assign one or more working tasks to the at least one humanoid robot includes individually assigning the plurality of tasks to the humanoid robots in the at least one team of humanoid robots.

In another aspect combinable one, some, or all of the previous aspects, the operations further include presenting a visual view of the at least one team of humanoid robots on a display device to a human operator.

In another example implementation, a method of operating a humanoid robot system includes initializing, with a control system, at least one humanoid robot within a humanoid robot system; executing, with the control system, a mission creator to create one or more working tasks for the at least one humanoid robot; and executing, with the control system, a mission assignor to assign one or more working tasks to the at least one humanoid robot.

An aspect combinable with the example implementation includes executing, with the control system, a diagnostic tool on the at least one humanoid robot.

Another aspect combinable with one, some, or all of the previous aspects further includes providing, with the control system, a communication from the at least one humanoid robot to a human operator.

In another aspect combinable with one, some, or all of the previous aspects, the at least one humanoid robot includes one or more eyes, a mouth, and a chest display, and providing the communication from the at least one humanoid robot to the human operator includes activating one or more of the one or more eyes, the mouth, or the chest display to provide a visual communication.

In another aspect combinable with one, some, or all of the previous aspects, the communication includes at least one of a boot-up sequence; a boot up greeting; a processing and confirmation communication; a working communication; a greeting during a working task communication; a maintenance mode communication; an error communication; or a charging communication.

In another aspect combinable with one, some, or all of the previous aspects, the visual communication includes a light communication with one or more LEDs.

In another aspect combinable with one, some, or all of the previous aspects, the control system includes a hand held controller.

Another aspect combinable with one, some, or all of the previous aspects further includes wirelessly communicating between the hand held controller and the at least one humanoid robot.

Another aspect combinable with one, some, or all of the previous aspects further includes controlling the at least one humanoid robot to perform a movement of the at least one humanoid robot with the hand held controller.

In another aspect combinable with one, some, or all of the previous aspects, the movement includes at least one of: walking, squatting, rotating an upper body assembly of the at least one humanoid robot, rotating the at least one humanoid robot, picking up an object, or bending over.

Another aspect combinable with one, some, or all of the previous aspects further includes presenting an image on the hand-held controller taken by the at least one humanoid robot.

Another aspect combinable with one, some, or all of the previous aspects further includes presenting an identification of the at least one humanoid robot among a team of humanoid robots on the hand-held controller.

In another aspect combinable with one, some, or all of the previous aspects, the at least one humanoid robot includes a plurality of humanoid robots.

In another aspect combinable with one, some, or all of the previous aspects, the plurality of humanoid robots are divided into at least two teams of humanoid robots.

In another aspect combinable with one, some, or all of the previous aspects, executing the mission creator to create one or more working tasks for the at least one humanoid robot includes executing the mission creator to create a mission for at least one team of humanoid robots.

In another aspect combinable with one, some, or all of the previous aspects, the mission includes a plurality of tasks.

In another aspect combinable with one, some, or all of the previous aspects, executing the mission assignor to assign one or more working tasks to the at least one humanoid robot includes individually assigning the plurality of tasks to the humanoid robots in the at least one team of humanoid robots.

Another aspect combinable with one, some, or all of the previous aspects further includes presenting a visual view of the at least one team of humanoid robots on a display device to a human operator

Implementations of systems and methods according to the present disclosure can include one, some, or all of the following features. For example, implementations according to the present disclosure can provide for optimized and efficient control, diagnostics, and communication with one or more humanoid robots, including teams of humanoid robots which have been assigned one or more tasks within a robotic system workflow.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a humanoid robot according to the present disclosure.

FIGS. 2A-2D show example implementations of a controller for a humanoid robot within a robotic workflow system according to the present disclosure.

FIGS. 3A and 3B show example implementations of a mission assignor for one or more humanoid robots within a robotic workflow system according to the present disclosure.

FIGS. 4A and 4B show example implementations of a mission creator for one or more humanoid robots within a robotic workflow system according to the present disclosure.

FIGS. 5A and 5B show example implementations of a diagnostic tool for one or more humanoid robots within a robotic workflow system according to the present disclosure.

FIGS. 6A-6C show example implementations of human interaction display components of a humanoid robot within a robotic workflow system according to the present disclosure.

FIGS. 6D and 6E are schematic diagrams that show example implementations of a humanoid robot deployment system according to the present disclosure.

FIG. 6F is a schematic diagram that shows an example implementation of an operator panel for a humanoid robot deployment system according to the present disclosure.

FIG. 6G is a schematic diagram that shows an example implementation of one or more humanoid robot deployment systems integrated into a case picking process according to the present disclosure.

FIG. 7 shows an example implementation of a robotic workflow control architecture according to the present disclosure.

FIG. 8 shows an example implementation of a robotic workflow control schema according to the present disclosure.

FIG. 9 shows an example implementation of a robotic workflow control suite according to the present disclosure.

FIG. 10 shows a schematic drawing of a control system that can be used in the workflow of FIG. 1 according to the present disclosure.

### DETAILED DESCRIPTION

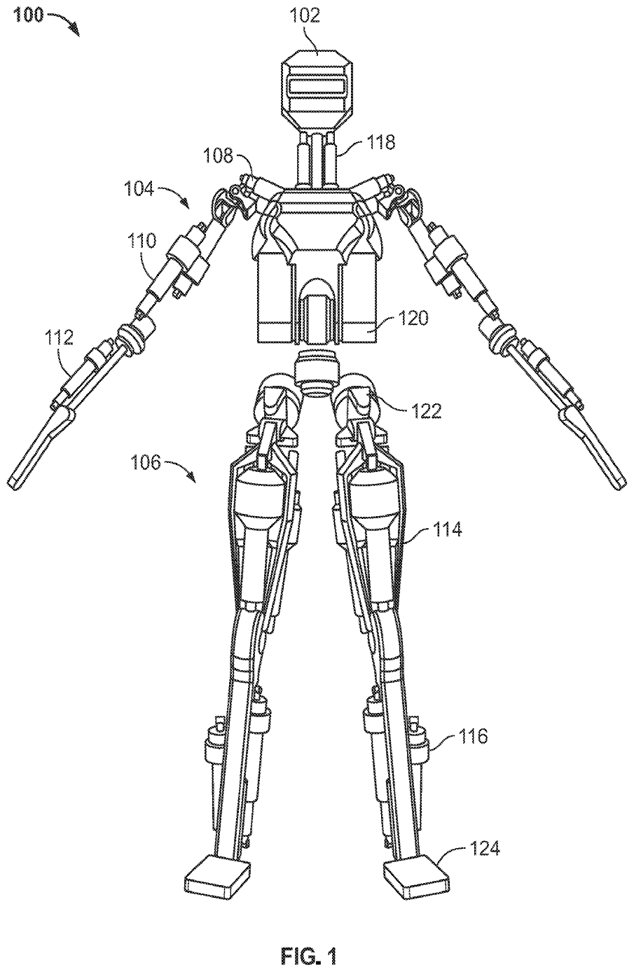

FIG. 1 is a schematic illustration of an example implementation of a humanoid robot 100 according to the present disclosure. Generally, many different types and forms of humanoid robots can be implemented with the UI and user experience (UX) systems and methods described here; the humanoid robot 100 provides just one example of particular features of the different humanoid robots that are contemplated by the present disclosure.

In the present disclosure, the term “humanoid robot” can refer to a robot that is generally human in shape, e.g., with a torso, a trunk, two torso appendages (i.e., arms/hands), two trunk appendages (i.e., legs/feet), and a head or skull appendage. However, the term “humanoid robot” can also refer to a robot that resembles just a portion of a human, such as only a torso with torso appendages, or only a trunk with trunk appendages. In addition, the present disclosure describes aspects of a humanoid robot (such as, for example, pairs of linear actuators that form a joint assembly or part of an appendage and operate in combination to adjust the joint assembly or appendage in two degrees of freedom through differential linear actuation) that can be applied in non-humanoid robots, such as quadruped robots or otherwise.

Humanoid robot 100 includes a head 102, an upper body assembly 104, and a lower body assembly 106 according to the present disclosure. Generally, humanoid robot 100 comprises a general purpose robot product that performs useful work in the real world (without the use of emotions) such as tasks that involve dangerous, hazardous, or even normal day-to-day tasks incapable (or capable) of being performed by a human being. Example tasks can include handling dangerous or hazardous materials (e.g., munitions, radioactive material, chemical material), loading and unloading (e.g., items or objects that are immovable or otherwise by a single or multiple human beings), or tasks performed in hazardous or dangerous environments.

Humanoid robot 100 can be autonomously controlled (untethered to any external control system) or human-controlled (e.g., tethered or wirelessly) to perform tasks (as described in more detail here). For example, humanoid robot 100 can perform useful work with mobility and kinematic movement that at least partially mimics that of a human being, and in spaces occupied by humans or not. The humanoid robot 100, in some aspects, is designed for practical portability and movement and for mass production.

The humanoid robot 100 can perform at various levels of autonomy. For example, example implementations of the humanoid robot 100 can be enabled for untethered locomotion testing, with some limited manipulation capabilities. In some aspects, example implementations of the humanoid robot 100 can be configured for full manipulation and locomotion.

The upper body assembly 104 includes, for example, a torso assembly 120, shoulder assemblies 108, upper arm assemblies 110, lower arm assemblies 112, and a neck assembly 118. The lower body assembly 106 includes a hip assembly 122 (that couples to the torso assembly 120), upper leg assemblies 114, lower leg assemblies 116, and foot assemblies 124 (that in some aspects are part of the lower leg assemblies 116).

The shoulder assemblies 108 can provide for flexion and extension of the arms of the humanoid robot 100 (e.g., lifting the arm to the front and rear). The shoulder assemblies 108 can provide for abduction and adduction (AA) of the arms of the humanoid robot 100. The upper arm assemblies 110 can provide for internal/external (IE) rotation of the arms of the humanoid robot 100. The combination of the upper and lower arm assemblies 110 and 112 (e.g., in combination with a radial actuator in some aspects) can provide for flexion-extension (FE) of the lower arms of the humanoid robot 100.

Appendages of the humanoid robot 100 can have at least two degrees of freedom of movement. For example, two degrees of shoulder freedom of roll and yaw can be provided through differential linear actuation of linear actuators of shoulder assemblies 108. Two degrees of torso freedom of roll and pitch can be provided through differential linear actuation of linear actuators of torso assembly 120. Two degrees of ankle freedom of roll and pitch can be provided through differential linear actuation of linear actuators of lower leg assemblies 116. Two degrees of hip freedom of roll and pitch can be provided through differential linear actuation of the pair of (smaller) linear actuators and a (larger) thigh linear actuator of upper leg assemblies 114.

Although not shown in FIG. 1, certain components, such as motor controllers for linear and radial actuators and other control components include and/or are connected by wiring or cabling. One issue that makes some robots appear less human and not conform to a human envelope is excessive cabling that is visible outside of a robot's outer shell. This excessive wiring may also present a snag hazard. Example implementations of the humanoid robot 100 minimize external cabling by maintaining cabling internally or minimizing external cabling. Example implementations of the humanoid robot 100 also help maintain cabling within the human envelope without putting undue stress on the cabling. More particularly, example implementations of the humanoid robot 100 can define wire paths across joints to minimize stress on both sides of the joint, which allows for no or minimum strain on the board connectors to which cabling connects.

Cabling and board joints may experience undue stress when the ratio of cable path length change to total cable length is too high. Minimizing the cable path length change through the range of motion of a joint to total cable length can ensure that cable does not stretch and put unnecessary stress on the cable, connectors, or boards. Furthermore, bending cables with too sharp a radius can induce local stresses in the cable, which can propagate to apply stresses on the connectors or boards. Example implementations of the humanoid robot 100 can implement features to minimize cable path length change and maximize bend radius.

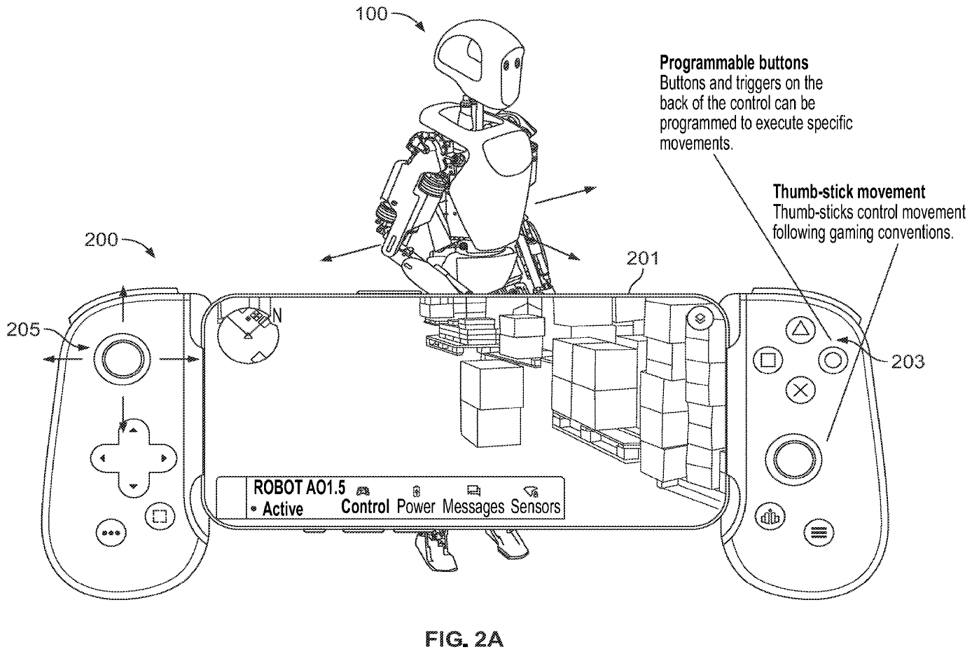

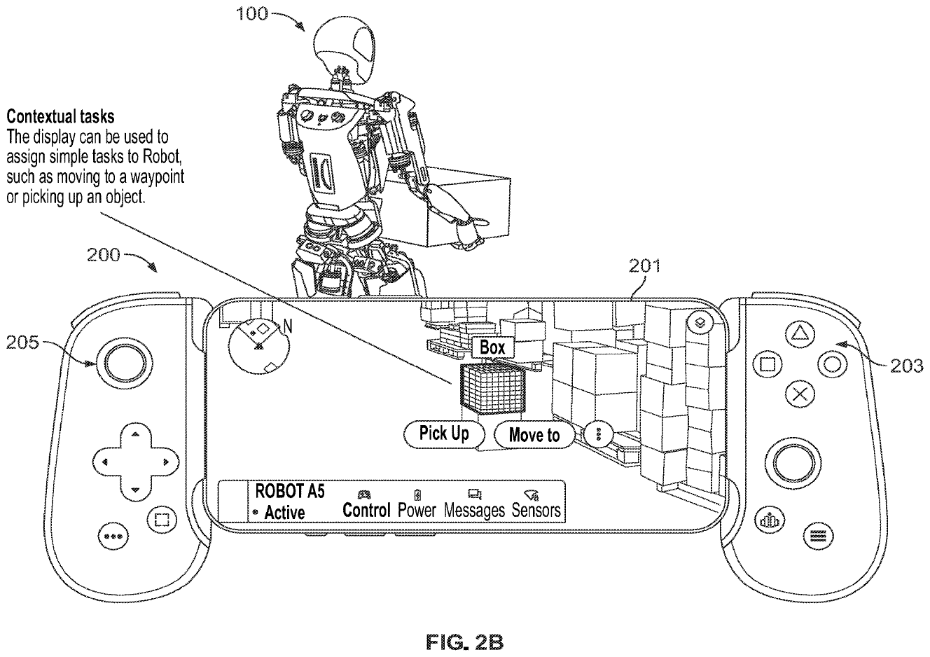

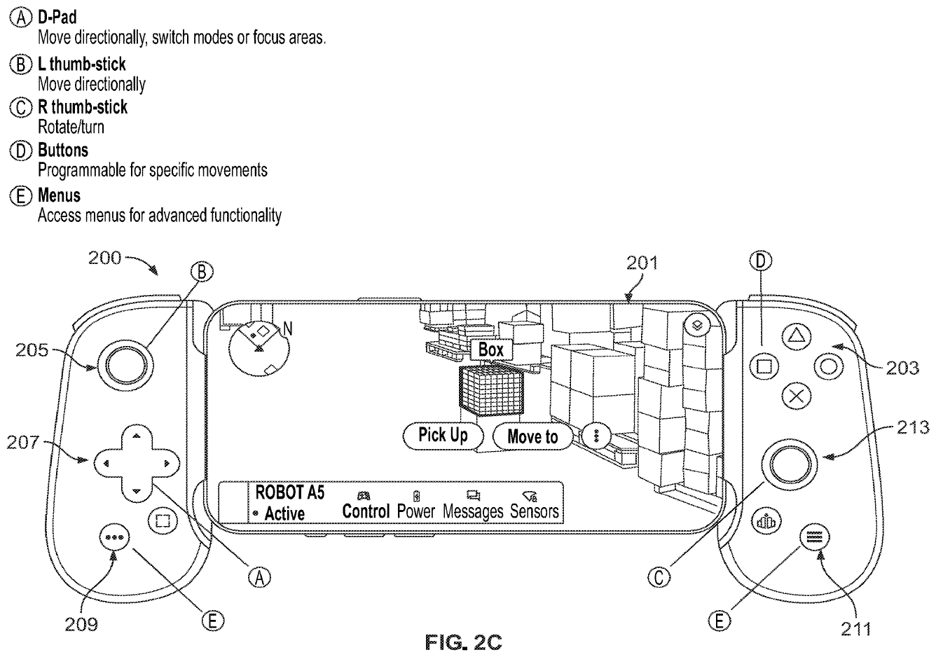

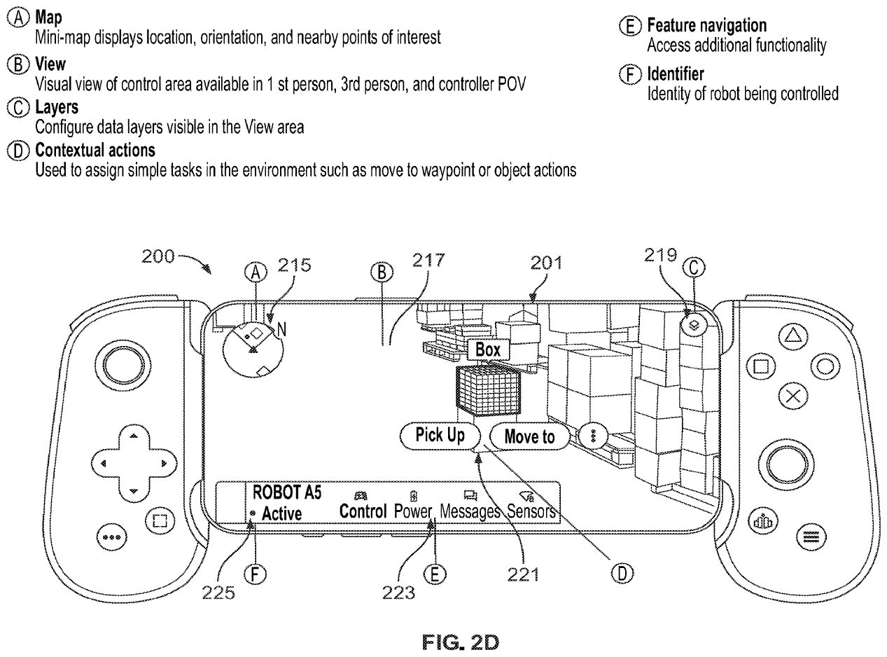

FIGS. 2A-2D show example implementations of a controller 200 for a humanoid robot 100 within a robotic workflow system according to the present disclosure. Controller 200 is an example implementation of a human operated, handheld controller 200 that can communicate (wired or wirelessly) with humanoid robot 100. In some aspects, humanoid robot 100 is controlled manually with controller 200 (such as by programmable buttons and/or thumb-stick). Alternatively, humanoid robot 100 can be controlled by controller 200 in combination with other control elements within a robotic workflow system.

In some aspects, a display portion 201 of the controller 200 can show an image (still or moving) taken by one or more image capture devices on the humanoid robot 100 (e.g., in real time). Thus, an operator of the controller 200 can view a real time image (still or moving) within a view path of the humanoid robot 100. The display portion 201 can be used to assign tasks to the humanoid robot 100, such as moving to a waypoint or picking up an object, among others. In some aspects, once commanded to perform the task (through the controller 200), the humanoid robot 100 carries out the task autonomously (e.g., through control software on the humanoid robot 100).

In some aspects, the programmable buttons 203 can be or include buttons and triggers, e.g., on the back or front of the controller 200 that can be programmed to execute specific movements. The thumb-stick movement 205 can be accomplished with the controller 200 similar to gaming conventions (and is exemplified by the stick with four-way arrows representing movement or rotation of the humanoid robot 100).

FIG. 2C shows other components of the example implementation of controller 200. For example, a D-pad 207 can be manipulated to move the humanoid robot 100 directionally and/or switch modes or focus areas. An L thumb-stick 209 can be manipulated to move the humanoid robot 100 directionally. An R thumb-stick 213 can be manipulated to rotate/turn the humanoid robot 100. Buttons 203 can be programmable for specific movements of the humanoid robot 100. Menus 211 can be set and accessed for advanced functionality of the humanoid robot 100.

FIG. 2D shows features of the display portion of the example implementation of controller 200. A map 215 (or mini-map) can display location, orientation, and nearby points of interest relative to the humanoid robot 100. The display provides a visual view 217 of a control area available in a 1st person, a 3rd person, and a controller POV relative to the humanoid robot 100. Data layers 219 can be configured and visible in the View area. Contextual actions 221 can be used to assign simple tasks to the humanoid robot 100 in the environment such as move to waypoint or object actions. Feature navigation 223 can provide for access to additional functionality of the humanoid robot 100. An identifier 225 can provide data and information related to an identity of the particular humanoid robot 100 (out of, for example, many humanoid robots 100, being controlled).

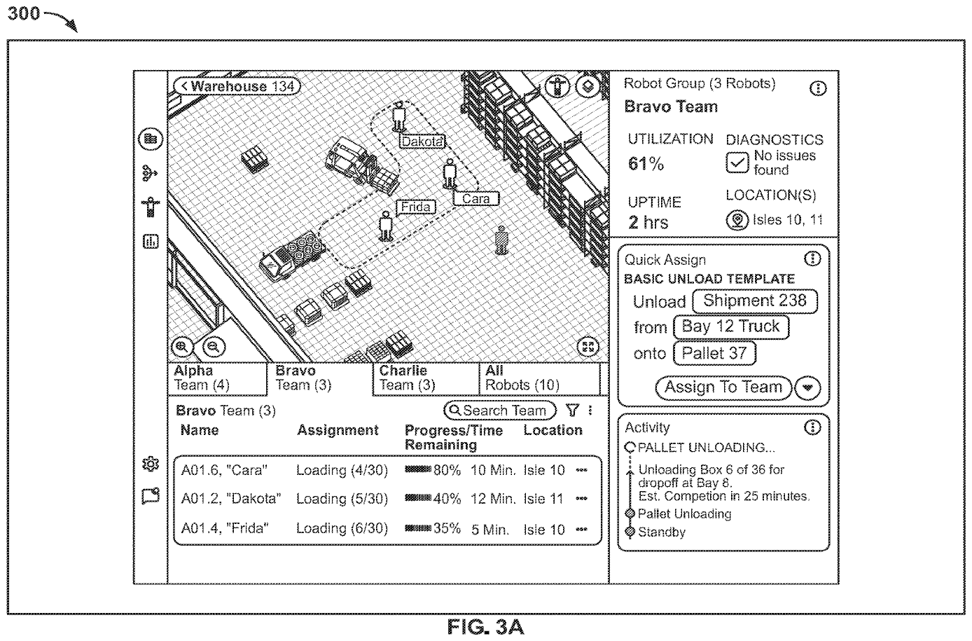

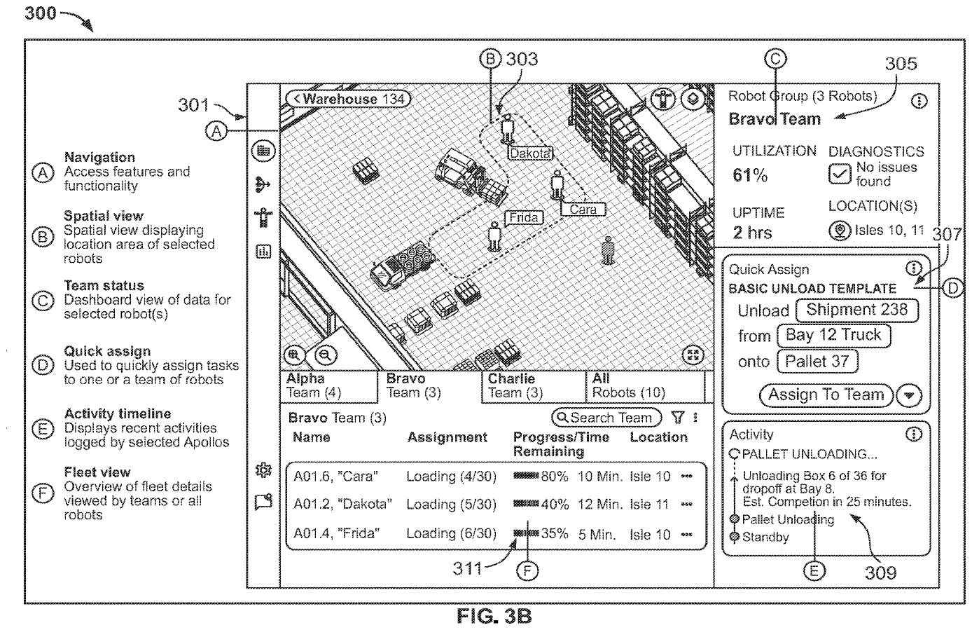

FIGS. 3A and 3B show example implementations of a mission assignor 300 for one or more humanoid robots 100 within a robotic workflow system according to the present disclosure. For example, a mission assignment (or mission assignor) can provide for tasks and missions (groups of tasks chained together) that can be assigned to individual humanoid robots 100 or groups of humanoid robots 100 working together as a team in a mission assigner. For workflows with multiple humanoid robots 100, the mission assigner can also serve as a fleet manager, providing robot status, task status and progression, and quick assignment capabilities. As shown in FIG. 3A, the assignor 300 shows: a graphical view (which could be an image view) of the humanoid robots 100 in a workflow setting; utilization, diagnostics, uptime, and location of the humanoid robots 100 on the “team;” assigned task description; activity description; and specific task progress, location, and assignment for each humanoid robot 100 on the team.

As shown in FIG. 3B, mission assignor 300 can show functionality, features, and UI details associated with the mission assigner. For example, navigation 301 can provide for access to features and functionality. Spatial view 303 can display a location area of selected humanoid robots 100. Team status 305 can provide a dashboard view of data for selected humanoid robots 100. Quick assign 307 can be used to quickly assign tasks to one or a team of humanoid robots 100. Activity timeline 309 displays recent activities logged by selected humanoid robots 100. Fleet view 311 is an overview of fleet details viewed by teams or all humanoid robots 100.

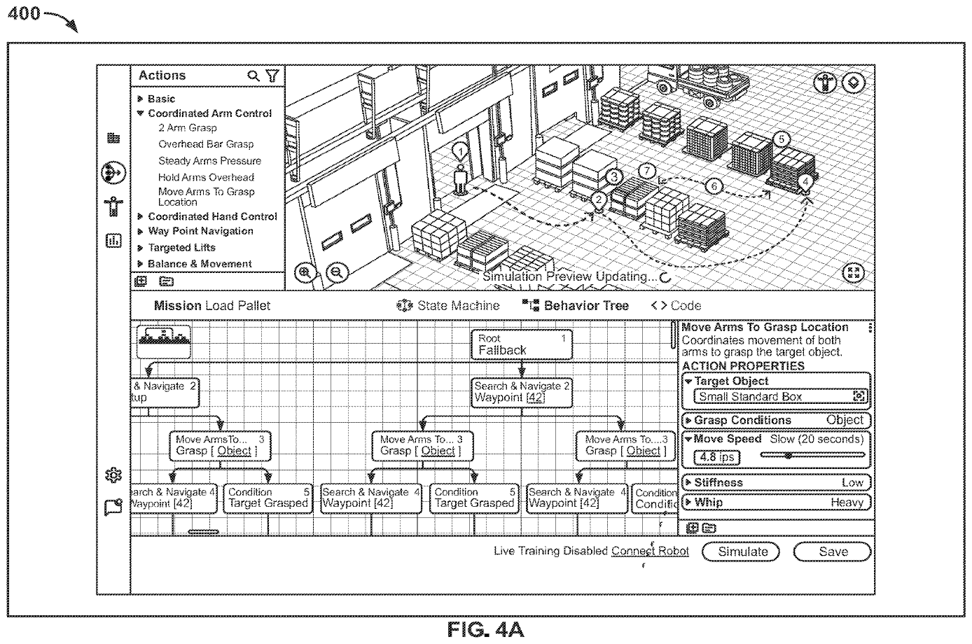

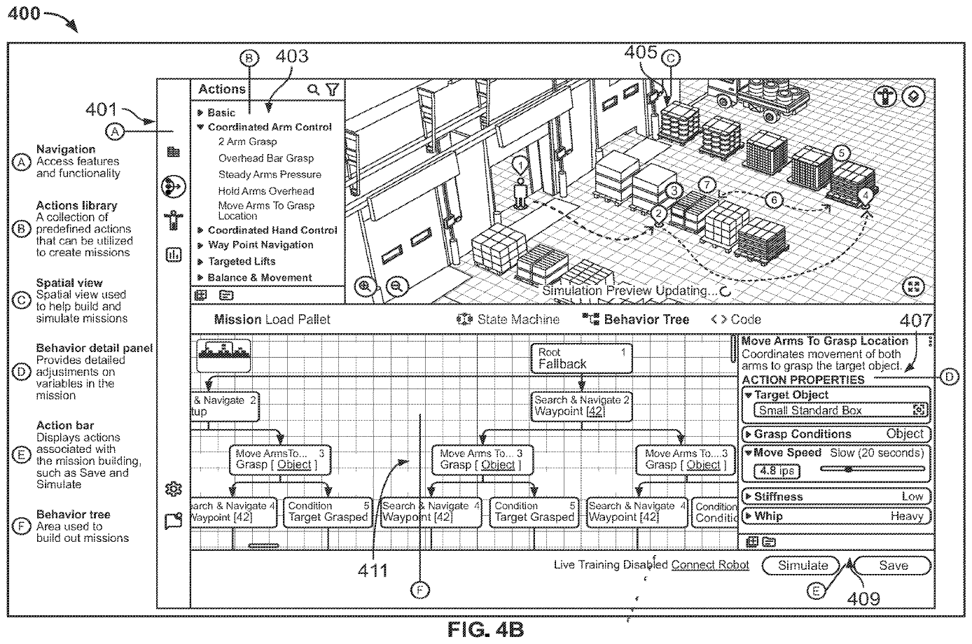

FIGS. 4A and 4B show example implementations of a mission creator (or control) 400 for one or more humanoid robots 100 within a robotic workflow system according to the present disclosure. For example, mission control is a component of the robotic workflow system that can be used to create the tasks, missions, and behaviors that are available in the mission assigner 300 and the controller 200. Missions for a humanoid robot 100 or a team of humanoid robots 100 can be created and customized to meet business needs and accommodate specific environmental factors. Operators of the robotic workflow are able to configure missions, interactions, and behaviors according to work environments, brand values, and expectations around worker and customer interactions with the humanoid robots 100.

As shown in FIG. 4B, the mission creator 400 can include one or more features. For example, navigation 401 can provide for access to features and functionality. Actions library 403 can provide a collection of predefined actions that can be utilized to create missions for one or more humanoid robots 100. Spatial view 405 can be used to help build and simulate missions for one or more humanoid robots 100. Behavior detail panel 407 can provide detailed adjustments on variables in the mission. Action bar 409 can display actions associated with the mission building, such as save and simulate. Behavior tree 411 is an area that can be used to build out missions.

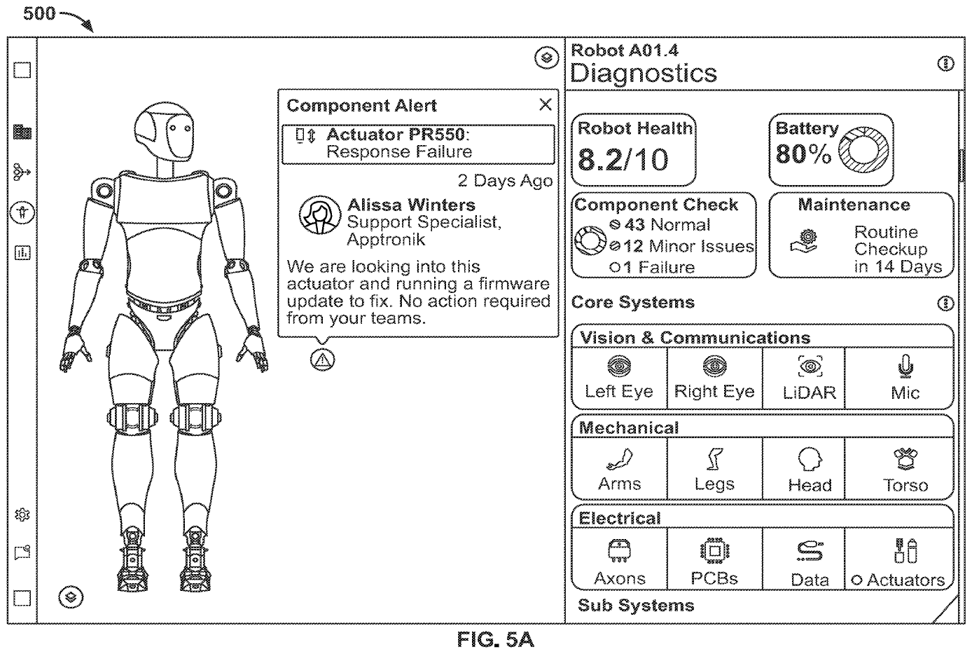

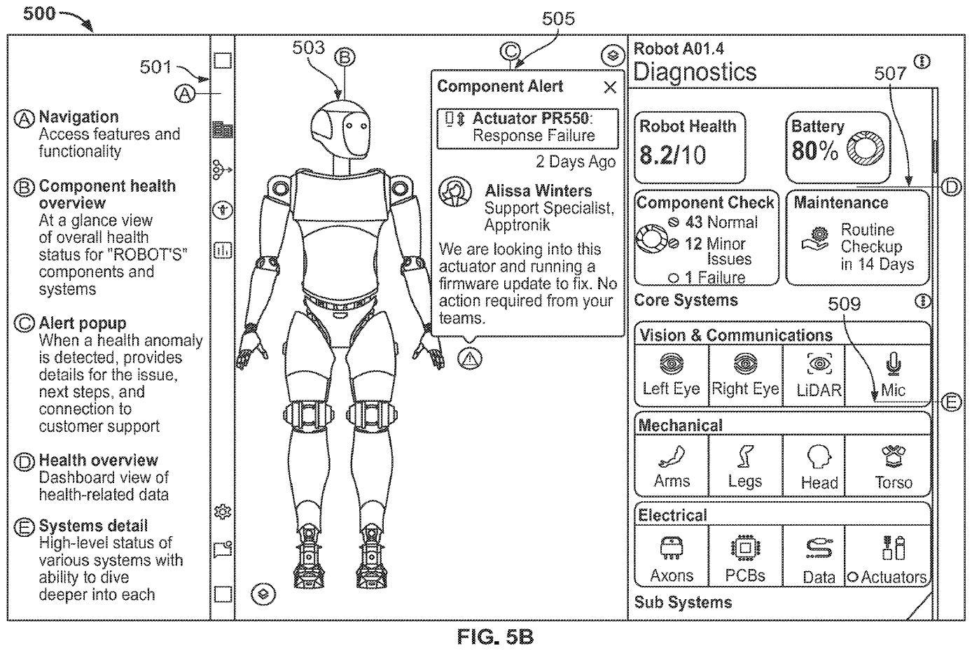

FIGS. 5A and 5B show example implementations of a diagnostic tool 500 for one or more humanoid robots 100 within a robotic workflow system according to the present disclosure. Diagnostic tool 500 can be used for troubleshooting with error codes, diagnostic software, and customer support for diagnosing problems with one or more humanoid robots 100. Viewing a humanoid robot 100 component and system status, functionality, and performance can be critical for both external and internal teams. When something goes wrong with an humanoid robot 100, the diagnostic tool 500 may be the first place a user will turn to. Thus, insight into the details of what is going on can be important, as well as details on next steps and a connection to customer support.

Diagnostic tool 500 can provide for features as shown in FIG. 5B. For example, navigation 501 can provide access to features and functionality. Component health overview 503 provides an at-a-glance view of overall health status for a humanoid robot 100 components and systems. Alert pop-up 505 can provide details for an issue, next steps, and connection to customer support when a health anomaly is detected in a humanoid robot 100. Health overview 507 is a dashboard view of health-related data for the humanoid robot 100. Systems detail 509 is a high-level status of various systems with ability to dive deeper into each.

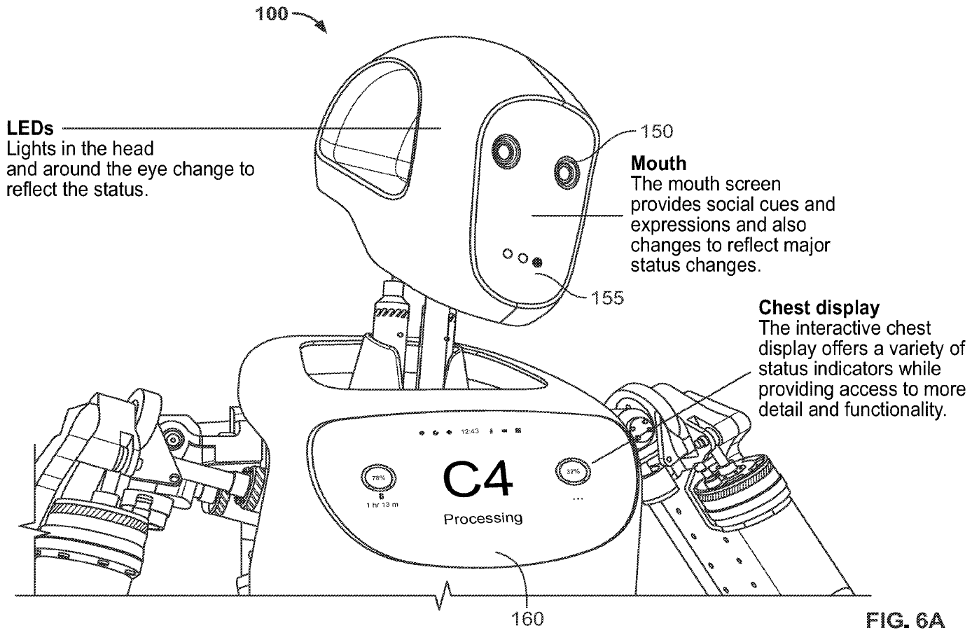

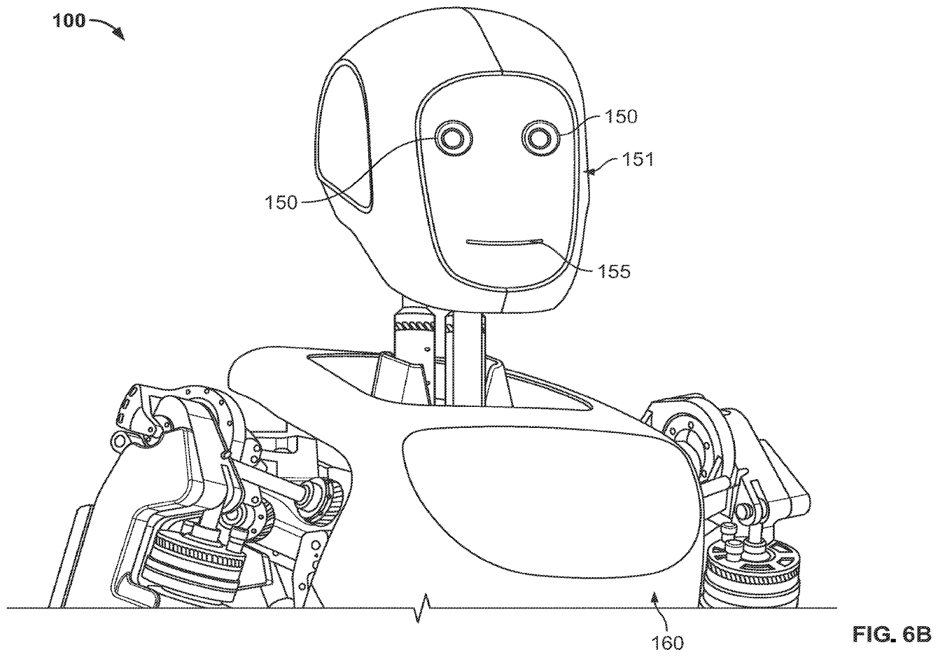

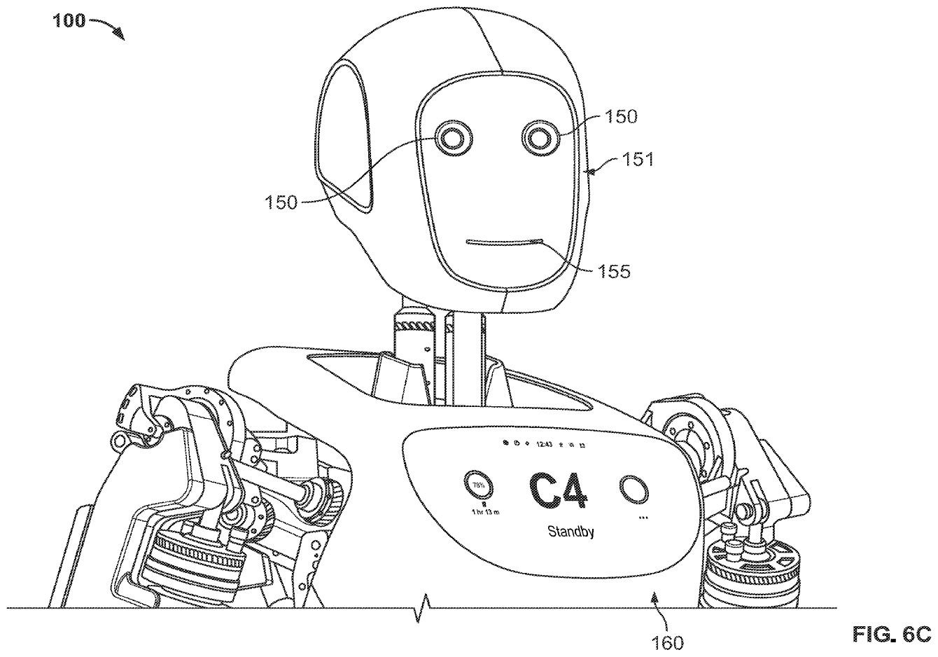

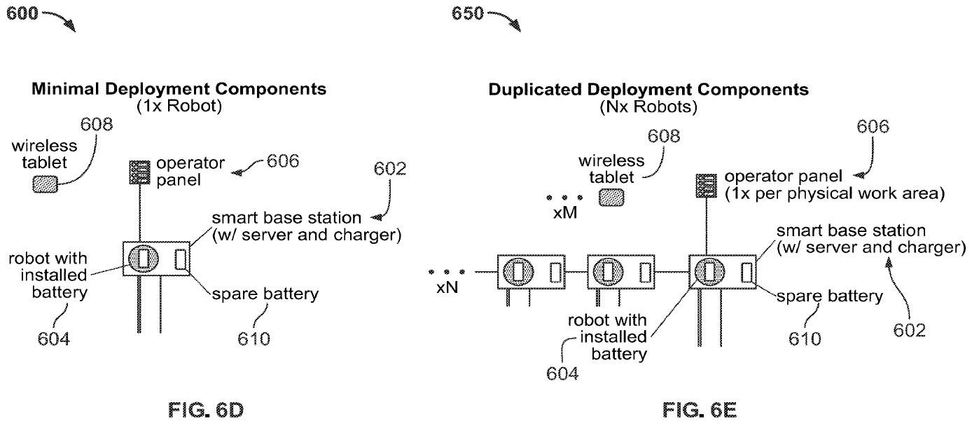

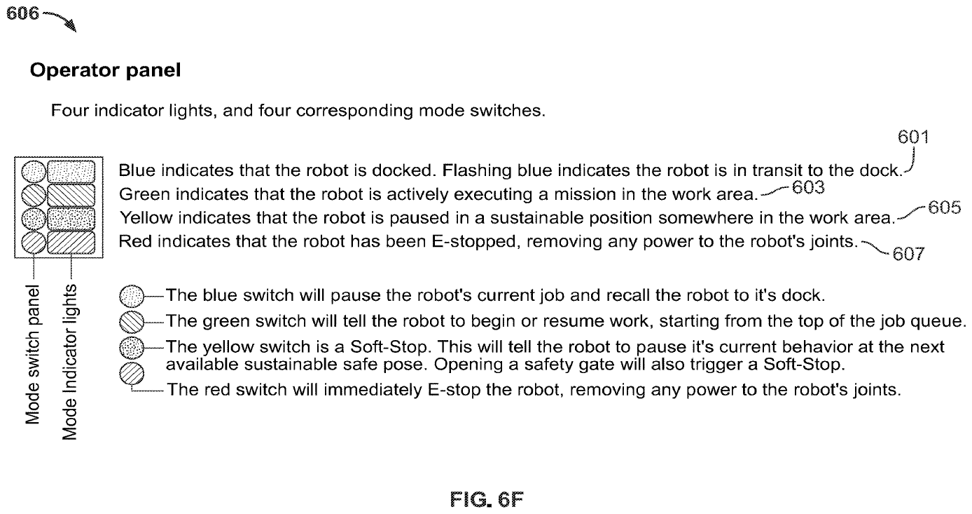

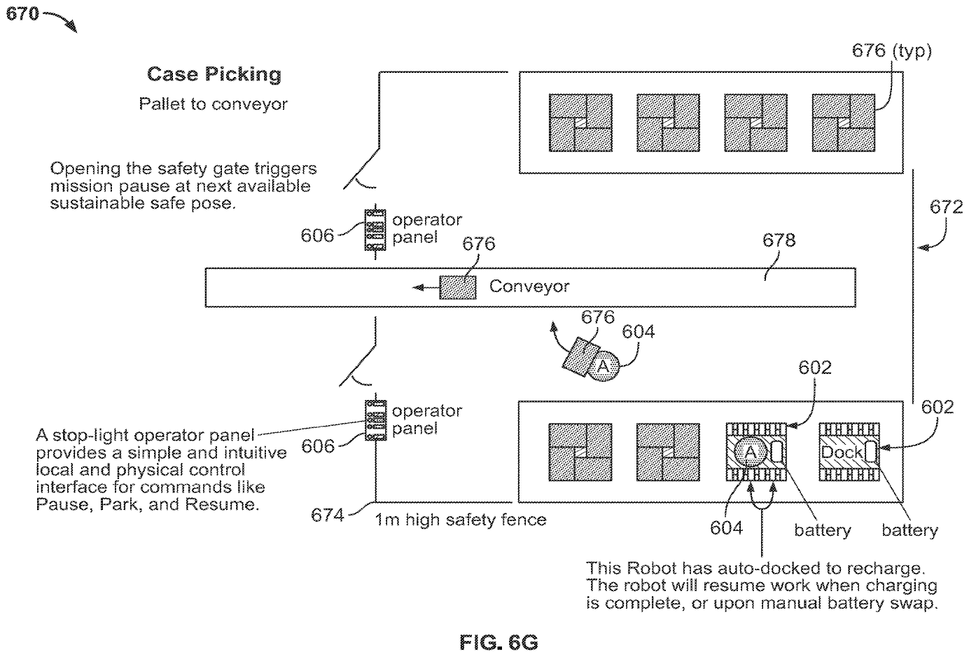

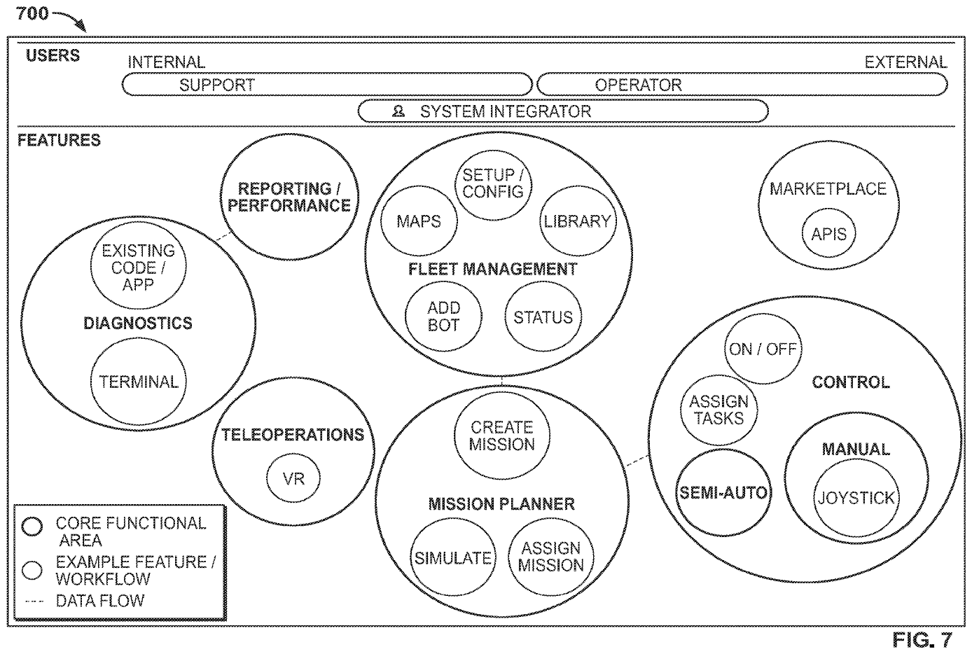

FIGS. 6A-6C show example implementations of human interaction display components of a humanoid robot 100 within a robotic workflow system according to the present disclosure. For example, human interactive display components can communicate information to a human operator. In some aspects, understanding what a humanoid robot 100 is doing at all times is critical for smooth operation. There are a few ways this information is physically conveyed through the humanoid robot 100. Aside from body posture, communication happens in the upper body and head, in some aspects through eyes 150 in the head, a mouth 155, and a chest display 160 (each implemented as LEDs for example). The eyes 150 and mouth 155 can work together to form expressions. These expressions include human-based patterns such as greeting, smiling, and making an introduction. They also reflect technical modes like charging and error states. The chest panel 160 can be an interactive, touch-enabled display. The chest panel 160 communicates an identity, mode, task status, and battery status of a humanoid robot 100. Additional details and functionality can be accessed directly from the panel 160 or remotely through controls (such as the controller 200).

As shown in FIGS. 6B and 6C, face expressions (on face 151, which includes eyes 150 and mouth 155) and chest displays (on chest panel 160) are designed to work together to avoid redundancy and distraction. Status of the humanoid robot 100 can be communicated through the face expressions on face 151 and chest displays on chest panel 160. For example, a boot-up sequence can be communicated when a humanoid robot 100 is powered on and in the process of getting systems up and running. A boot up greeting can be communicated when a humanoid robot 100 has reached the end of the boot up sequence. A processing and confirmation communication can be displayed when the humanoid robot 100 is processing an assigned task and confirming the task is understood. A working communication can be displayed when humanoid robot 100 is carrying out an assigned task. A greeting during a working task communication can be displayed when humanoid robot 100 is in the middle of a task and greets someone. A maintenance mode communication can be displayed when humanoid robot 100 is put in maintenance mode for repair, modifications, or inspection. An error communication is displayed when humanoid robot 100 has an error that is detected. A charging communication is displayed when the humanoid robot 100 is charging, and if the humanoid robot 100 is charging while in the middle of a task, the task communication is displayed on the chest panel 160 as well.

FIGS. 6D and 6E are schematic diagrams that show example implementations of a humanoid robot deployment system according to the present disclosure. For example, FIG. 6D shows an example implementation of a humanoid robot deployment system 600 for a single humanoid robot 604 (e.g., such as the humanoid robot 100 or any humanoid robot according to the present disclosure). In this example implementation, the humanoid robot deployment system 600 includes a base station 602, which includes, for instance, at least one spare battery 610 and a charging location for the humanoid robot 604, as well as the spare battery 610. Thus, in this example, the humanoid robot 604 can return and dock to the base station 602 and charge an on-board battery of the humanoid robot 604, or be fitted with a different, fully charged spare battery 610. The example implementation of the humanoid robot deployment system 600 can also include an operator panel 606 communicably coupled to the base station 602 (described more fully with reference to FIG. 6F). A controller 608 (such as a wireless controller in the form of a tablet or other mobile device) can also be included in the humanoid robot deployment system 600. The controller 608 can be, for example, similar to or the same as the controller 200.

FIG. 6E shows an example implementation of a humanoid robot deployment system 650 for multiple humanoid robots 604 (e.g., such as the humanoid robot 100 or any humanoid robot according to the present disclosure). In this example implementation, the humanoid robot deployment system 650 includes multiple base stations 602 (e.g., 1 per humanoid robot 604), which includes, for instance, at least one spare battery 610 and a charging location for the particular humanoid robot 604 assigned to the base station 602. The example implementation of the humanoid robot deployment system 650 can also include, in this instance, a single operator panel 606 that is communicably coupled to the base stations 602 in the humanoid robot deployment system 650. In this example, multiple controllers 608 (e.g., 1 per humanoid robot 604) can also be included in the humanoid robot deployment system 650.

The example implementations of the humanoid robot deployment system 600 and humanoid robot deployment system 650 can provide for functionality and features that facilitate operation of the one or more humanoid robots 604 associated with the systems. For example, the base station 602 provides a location that a humanoid robot 604 can dock to as well as charging capability for the humanoid robot 604 (i.e., with shore power) and separate battery 610. While the humanoid robot 604 is working, the spare battery 610 is charging. When the humanoid robot 604 depletes its battery, the robot 604 can auto dock and either automatically charge (e.g., autonomously with zero human intervention) or have a human swap out the battery quickly to achieve, e.g., 22 hour/7 day operational uptime.

In some aspects, a charge dock on the base station 602 can charge a humanoid robot 604 simultaneously with the spare battery 610. In some aspects, the charge dock on the base station 602 can charge the humanoid robot 604 or the spare battery 610 at any given time. During a battery swap, the humanoid robot 604 can remain charging while a battery swap occurs.

In some aspects, the operator panel 606 and base station 602 can be communicably coupled (e.g., wired or wirelessly) in a closed private network (that is, optionally, encrypted). Thus, the humanoid robot deployment system 600 (or 650) can form a secure perimeter that shields humanoid robots 604 from outside access. Optionally, the humanoid robot deployment system 600 or humanoid robot deployment system 650 can be connected to an external network (e.g., through the operator panel 606), such as by Ethernet jack, WiFi, 4G/5G, other protocol.

FIG. 6F is a schematic diagram that shows an example implementation of the operator panel 606 for a humanoid robot deployment system according to the present disclosure. In an example implementation, the operator panel 606 can include multiple lights/switches that provide for multiple indicators/functionality. In this example implementation, the operator panel 606 includes four lights/switches of different colors. A first light-switch 601 can be, e.g., blue, and can indicate that the humanoid robot 604 is docked at the base station 602. A flashing first light-switch 601 indicates that the humanoid robot 604 is in transit to the base station 602. The first light-switch 601 can be operated to pause the current job and recall the humanoid robot 604 to the base station 602.

A second light-switch 603 can be, e.g., green, and can indicate that the humanoid robot 604 is actively executing a mission in a work area. The second light-switch 603 can be operated to tell the humanoid robot 604 to begin or resume work starting from a top of a job queue.

A third light-switch 605 can be, e.g., yellow, and can indicate that the humanoid robot 604 is paused in a sustainable position somewhere in the work area. The third light-switch 605 can be a soft stop switch and can be operated to tell the humanoid robot 604 to pause a current behavior at a next available sustainable safe pose. Other actions can also trigger a soft stop. For example, in the example case picking workflow of FIG. 6G, opening a safety gate can also trigger a soft stop.

A fourth light-switch 607 can be, e.g., red, and can indicate that the humanoid robot 604 has been E-stopped, removing any power to the joints of the humanoid robot 604. The fourth light-switch 607 can be operated to immediately E-stop the humanoid robot 604.

FIG. 6G is a schematic diagram that shows an example implementation of one or more humanoid robot deployment systems integrated into a case picking process 670 according to the present disclosure. In this example process 670 (or workflow 670), multiple humanoid robot deployment systems 600 (or one or more humanoid robot deployment systems 650) can be used to operate multiple humanoid robots 604 from base stations 602 in the workflow 670. As shown in this example, the base stations 602 can be collocated within a work area 672 (e.g., bounded by a safety fence 674) along with one or more pallets that hold product 676. In this example, one or more operator panels 606 can also be collocated with the work area 672 to provide for operational control (e.g., as described with reference to FIG. 6F) of the humanoid robots 604.

In this example workflow 670, the humanoid robots 604 are autonomously working to, for example, load product 676 from pallets in the work area 672 onto a conveyor 678, where such product 676 is carried out of the work area 672. The humanoid robots 604 can return to the base stations 602 to charge when needed (e.g., autonomously) or when commanded by the operator panel 606. In this example, the humanoid robots 604 can also be E-stopped when, for example, a gate or door of the work area 672 (e.g., within the fence 674) is opened.

FIG. 7 shows an example implementation of a robotic workflow control architecture 700 according to the present disclosure. Robotic workflow control architecture 700 provides one example architecture that can be implemented with the humanoid robot 100 or teams of humanoid robots 100. Core functional areas, as well as example features/workflows in the architecture 700 can be modified depending on, for example, capabilities of the particular humanoid robot 100 as well as workflow needs for a user of the humanoid robot 100 (or humanoid robots 100).

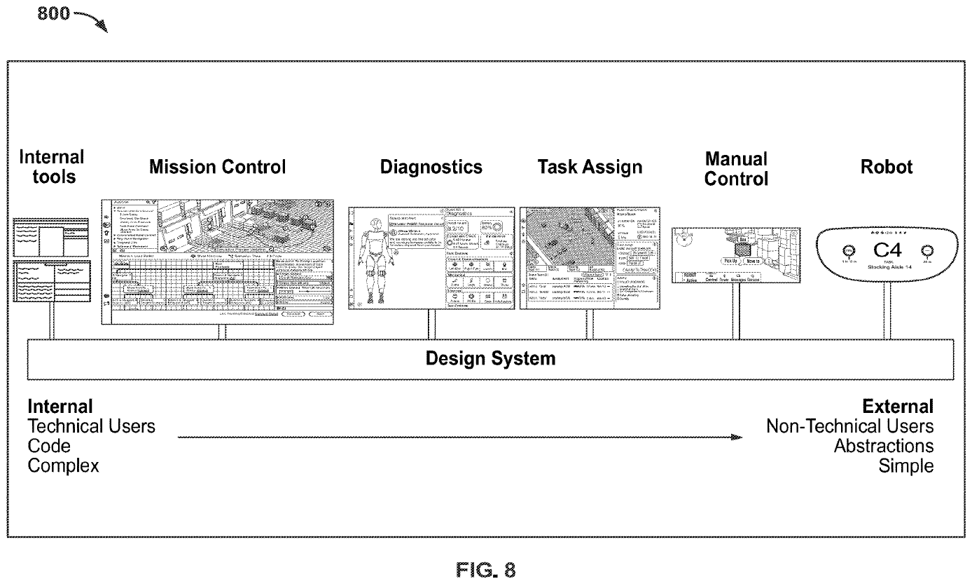

FIG. 8 shows an example implementation of a robotic workflow control schema 800 according to the present disclosure. Robotic workflow control schema 800 provides one example schema that can be implemented with the humanoid robot 100 or teams of humanoid robots 100. As shown control functionality progresses from technical, internal, and complex to simple control abstractions used by customers or users of the humanoid robot 100 (or humanoid robots 100). Functionality of the schema 800 can be modified depending on, for example, capabilities of the particular humanoid robot 100 as well as workflow needs for a user of the humanoid robot 100 (or humanoid robots 100).

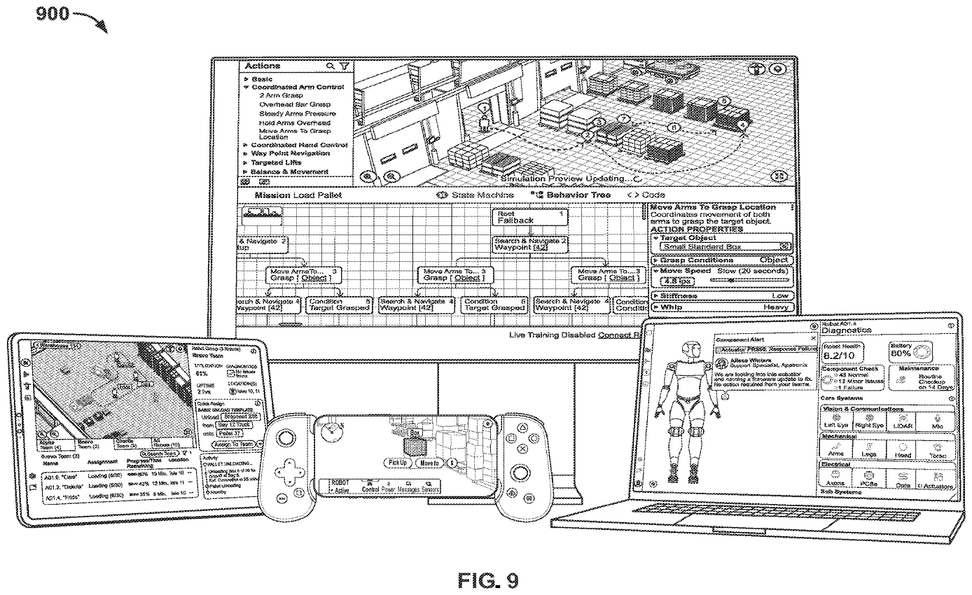

FIG. 9 shows an example implementation of a robotic workflow control suite 900 according to the present disclosure. For example, the described workflow functionality, such as mission assignor, mission control, task assign, and diagnostics can be accessed or otherwise used from several different control components, including controller 200, back-end devices such as servers, or front end user devices such as tablets, phones, laptops, and desktop workstations.

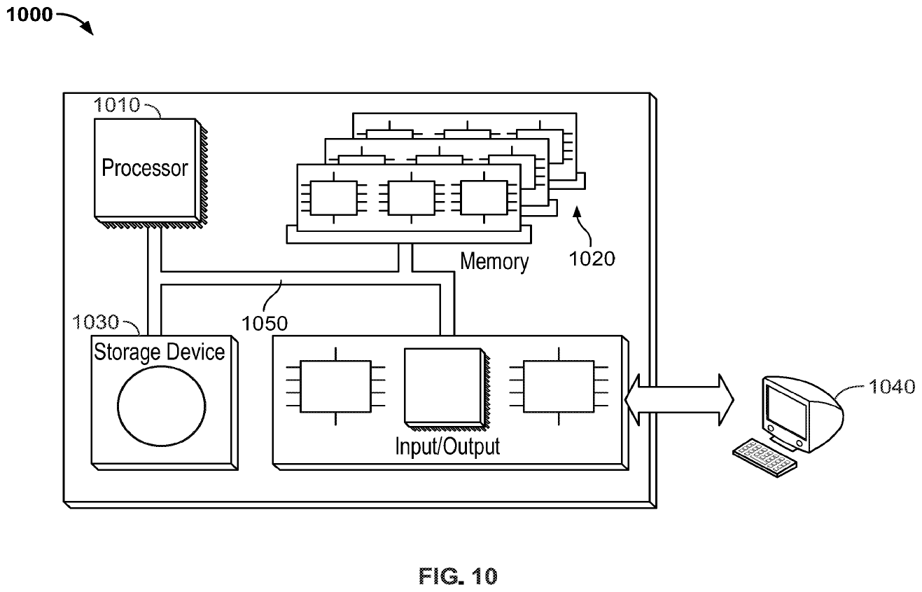

FIG. 10 shows a schematic drawing of a control system that can be used in a robotic workflow according to the present disclosure. For example, all or parts of the control system 1000 (or control systems 1000) can be used for the operations described previously, for example as or as part of one or more components of the robotic workflow control suite 900. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the control system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 may be a floppy disk device, a hard disk device, an optical disk device, a tape device, flash memory, a solid state device (SSD), or a combination thereof.

The input/output device 1040 provides input/output operations for the controller 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A humanoid robot system, comprising:
at least one humanoid robot; and
a control system communicably coupled to the at least one humanoid robot and configured to perform operations comprising:
executing a mission creator to create one or more working tasks for the at least one humanoid robot; and
executing a mission assignor to assign one or more working tasks to the at least one humanoid robot.

2. The humanoid robot system of claim 1, wherein the operations further comprise executing a diagnostic tool on the at least one humanoid robot.

3. The humanoid robot system of claim 1, wherein the operations further comprise providing a communication from the at least one humanoid robot to a human operator.

4. The humanoid robot system of claim 3, wherein the at least one humanoid robot comprises one or more eyes, a mouth, and a chest display, and providing the communication from the at least one humanoid robot to the human operator comprises activating one or more of the one or more eyes, the mouth, or the chest display to provide a visual communication.

5. The humanoid robot system of claim 3, wherein the communication comprises at least one of:
a boot-up sequence;
a boot up greeting;
a processing and confirmation communication;
a working communication;
a greeting during a working task communication;
a maintenance mode communication;
an error communication; or
a charging communication.

6. The humanoid robot system of claim 3, wherein the visual communication comprises a light communication with one or more LEDs.

7. The humanoid robot system of claim 1, wherein the control system comprises a hand held controller.

8. The humanoid robot system of claim 7, wherein the controller is in wireless communication with the at least one humanoid robot.

9. The humanoid robot system of claim 7, wherein the operations further comprise controlling the at least one humanoid robot to perform a movement of the at least one humanoid robot with the hand held controller.

10. The humanoid robot system of claim 9, wherein the movement comprises at least one of: walking, squatting, rotating an upper body assembly of the at least one humanoid robot, rotating the at least one humanoid robot, picking up an object, or bending over.

11. The humanoid robot system of claim 7, wherein the operations further comprise presenting an image on the hand-held controller taken by the at least one humanoid robot.

12. The humanoid robot system of claim 7, wherein the operations further comprise presenting an identification of the at least one humanoid robot among a team of humanoid robots on the hand-held controller.

13. The humanoid robot system of claim 1, wherein the at least one humanoid robot comprises a plurality of humanoid robots.

14. The humanoid robot system of claim 13, wherein the plurality of humanoid robots are divided into at least two teams of humanoid robots.

15. The humanoid robot system of claim 13, wherein the operation of executing the mission creator to create one or more working tasks for the at least one humanoid robot comprises:
executing the mission creator to create a mission for at least one team of humanoid robots, the mission comprising a plurality of tasks.

16. The humanoid robot system of claim 13, wherein the operation of executing the mission assignor to assign one or more working tasks to the at least one humanoid robot comprises:
individually assigning the plurality of tasks to the humanoid robots in the at least one team of humanoid robots.

17. The humanoid robot system of claim 13, wherein the operations further comprise presenting a visual view of the at least one team of humanoid robots on a display device to a human operator.

18. A method of operating a humanoid robot system, comprising:
initializing, with a control system, at least one humanoid robot within a humanoid robot system;
executing, with the control system, a mission creator to create one or more working tasks for the at least one humanoid robot; and
executing, with the control system, a mission assignor to assign one or more working tasks to the at least one humanoid robot.

19. The method of claim 18, comprising executing, with the control system, a diagnostic tool on the at least one humanoid robot.

20. The method of claim 18, comprising providing, with the control system, a communication from the at least one humanoid robot to a human operator.

21. The method of claim 20, wherein the at least one humanoid robot comprises one or more eyes, a mouth, and a chest display, and providing the communication from the at least one humanoid robot to the human operator comprises activating one or more of the one or more eyes, the mouth, or the chest display to provide a visual communication.

22. The method of claim 20, wherein the communication comprises at least one of:
a boot-up sequence;
a boot up greeting;
a processing and confirmation communication;
a working communication;
a greeting during a working task communication;
a maintenance mode communication;
an error communication; or
a charging communication.

23. The method of claim 20, wherein the visual communication comprises a light communication with one or more LEDs.

24. The method of claim 18, wherein the control system comprises a hand held controller.

25. The method of claim 24, comprising wirelessly communicating between the hand held controller and the at least one humanoid robot.

26. The method of claim 24, comprising controlling the at least one humanoid robot to perform a movement of the at least one humanoid robot with the hand held controller.

27. The method of claim 26, wherein the movement comprises at least one of: walking, squatting, rotating an upper body assembly of the at least one humanoid robot, rotating the at least one humanoid robot, picking up an object, or bending over.

28. The method of claim 24, comprising presenting an image on the hand-held controller taken by the at least one humanoid robot.

29. The method of claim 24, comprising presenting an identification of the at least one humanoid robot among a team of humanoid robots on the hand-held controller.

30. The method of claim 18, wherein the at least one humanoid robot comprises a plurality of humanoid robots.

31. The method of claim 30, wherein the plurality of humanoid robots are divided into at least two teams of humanoid robots.

32. The method of claim 30, wherein executing the mission creator to create one or more working tasks for the at least one humanoid robot comprises:
executing the mission creator to create a mission for at least one team of humanoid robots, the mission comprising a plurality of tasks.

33. The method of claim 30, wherein executing the mission assignor to assign one or more working tasks to the at least one humanoid robot comprises:
individually assigning the plurality of tasks to the humanoid robots in the at least one team of humanoid robots.

34. The method of claim 30, comprising presenting a visual view of the at least one team of humanoid robots on a display device to a human operator.
